(19) United States
(12) Patent Application Publication
(10) Pub. No.: US 2013/0142311 A1
(43) Pub. Date: Jun. 6, 2013

(54) METHOD FOR THE AUTOMATIC CONTROL OF MAXIMUM POWER FOR X-RAY APPARATUSES, AND DEVICE REQUIRED FOR SAME

(71) Applicants: Angel Diaz Carmena, Algete (Madrid) (ES); Anibal Gomez Rodriguez, Algete (Madrid) (ES); Francisco Diaz Carmena, Algete (Madrid) (ES)

(72) Inventors: Angel Diaz Carmena, Algete (Madrid) (ES); Anibal Gomez Rodriguez, Algete (Madrid) (ES); Francisco Diaz Carmena, Algete (Madrid) (ES)

(21) Appl. No.: 13/814,706

(22) PCT Filed: Sep. 28, 2010
(86) PCT No.: PCT/ES2010/070624

§ 371 Date: Feb. 6, 2013

(51) Int. Cl. H05G 1/10

(52) U.S. Cl. CPC H05G 1/10
USPC 378/111

(57) ABSTRACT

A method of operating an x-ray unit that supplies the maximum power at all times, for which the supply or input voltage at the x-ray tube must be half the power supply voltage ((Vbat)/2 or (Vline)/2), which will be termed the reference voltage (Vref). In case of a deviation from the reference voltage, the method modifies the current supplied, changing the exposure time so that the maximum power is delivered at all times. In short, it is based on a method that regulates the tube current as a function of the supply voltage (of the batteries or the grid).

### OBJECT OF THE INVENTION

The object of the invention, as described by its title, is a method for automatic maximum power regulation for an x-ray unit, whether battery-powered or connected to the power grid, and the device that carries out this method.

The present invention is characterised by the special features of the method stages, which allow supplying the maximum power to the x-ray unit at all times, allowing to obtain x-ray images with optimum quality for the unit.

### BACKGROUND OF THE INVENTION

Portable x-ray units or movable x-ray units connected to the power grid suffer from a common drawback: the voltage drop in the power line at the time of discharge, which is unknown and even unpredictable, and therefore cannot be compensated for. This voltage drop at the time of discharge completely distorts the x-ray image (because the necessary kVp are not reached), resulting in an image that does not allow analysing the patient's internal condition.

This is particularly relevant in home medical assistance, where a portable x-ray unit is used to take an x-ray image of a person who, for whatever reason, cannot be taken to a hospital. It is also relevant in farms when veterinaries wish to take an x-ray of an animal, or when a power cable is deployed to the portable x-ray unit.

In all of these cases, whether due to the power line itself or to the use of an extension cord, a voltage drop usually occurs at the time of discharge. This distorts the radiographic image so that the part of interest cannot be seen clearly.

The solution hitherto used for these problems is to reduce the unit's power. Thus, for example, 4 kW units are made to work at 1 kW power levels, which reduces the unit's capabilities, with the resulting dissatisfaction of users and buyers of these mobile units.

An identical problem occurs in x-ray units powered by batteries, as the batteries have an internal resistance that increases over time due to battery ageing and oxidation, reducing the maximum power that the batteries can supply. This is, units with aged batteries cannot produce x-ray images of sufficient quality.

Therefore, the object of the present invention is to develop a method for automatic regulation of the maximum power supplied to portable x-ray units, whether these are powered by the power grid or by batteries, so that they can supply the maximum power at the time of discharge, thereby preventing the loss in quality of the x-ray images.

### DESCRIPTION OF THE INVENTION

The object of the invention is a method for automatic regulation of the maximum power delivered to an x-ray unit, with the aim of having maximum power delivered at all times.

The process for obtaining x-ray images has two basic values or parameters that allow obtaining images of different type. On one hand, the peak value of the voltage applied, expressed as kVp, and on the other the product of the mA supplied and the exposure time, also known as mAs.

The peak kilovolts value gives the penetration of the radiation. An image of a rib is not the same as that of an internal organ such as a lung; to see the organ through the bone it is necessary to raise the value of kVp so that it can pass through the bone easily.

The product of the milliamperes and exposure time (mAs) make the image clearer or darker.

However, if the value of the kV applied is not appropriate, because the grid or the batteries cannot supply this voltage value, the resulting images have insufficient quality.

On another hand, it is known that the power supply circuit consists of a power supply (of the grid or line or of the batteries) connected in series to a resistance, which in the case of x-ray units powered by batteries is the internal resistance of the batteries and in the case of x-ray units powered by the grid or a supply line is the line resistance. The terminals of this circuit are connected to a resistance, as it is known that the maximum power is obtained at the connection ends of the resistance when the external resistance connected is equal to the internal resistance of the batteries or the line resistance, and therefore when the voltage at the terminals of the external resistance is half of the power supply voltage.

It is known that for an x-ray unit operating with universal voltage (90VAC to 264VAC) the minimum power supply voltage for operating the x-ray unit is 90 volts, so that the power supply voltage should never be less than this value, even if it is not the same as the maximum power voltage. For example, for a unit connected to 120V the maximum power is obtained at 60V, but the unit cannot operate under 90V. Units connected to batteries do not have this limitation, as they are designed specifically for this purpose and can always operate at optimum power.

Therefore, the object of the operating method for the x-ray unit is to supply the maximum power at all times, for which the supply or input voltage at the x-ray tube must be half the power supply voltage ((Vbat)/2 or (Vline)/2), referred to as the reference voltage (Vref); in case of a deviation from the reference voltage, the method modifies the current supplied, changing the exposure time so that the maximum power is delivered at all times. In short, it is based on a method that regulates the tube current as a function of the supply voltage (of the batteries or the grid).

In one possible embodiment the method comprises the following stages:
First, calculating the reference voltage, which if the x-ray unit is powered by the grid will be half of the line voltage, provided this value is greater than 90 volts and otherwise it will be 90 volts; and if it is battery powered the reference voltage will be half of the voltage supplied by the batteries.
Then comparing the reference voltage, which will be half of the supply voltage (from either the grid or the batteries), to the input voltage supplied to the x-ray unit, regulating the voltage and thereby the power to obtain a reference value for the current to supply.
This value obtained for the reference current is compared to the input current in order to obtain the filament current, which is the current which, with the input voltage being half the line or battery voltage, allows supplying the maximum power at all times.

### DESCRIPTION OF THE DRAWINGS

To complete the description made below and to aid a better understanding of its characteristics, the present descriptive memory is accompanied by a set of drawings, the figures of which represent the most significant details of the invention for purposes of illustration only and in a non-limiting sense.

FIG. 1 shows the simplified wiring scheme in the maximum power supply conditions.

FIG. 2 shows a representation of the microprocessor in charge of calculating the reference voltage.

FIG. 3 shows the representation of the stages for calculating the reference voltage.

FIG. 4 shows a representation of the power control process.

FIG. 5 shows a representation of the device needed to carry out this method.

### PREFERRED EMBODIMENT OF THE INVENTION

In view of the figures, a preferred embodiment of the proposed invention is described below.

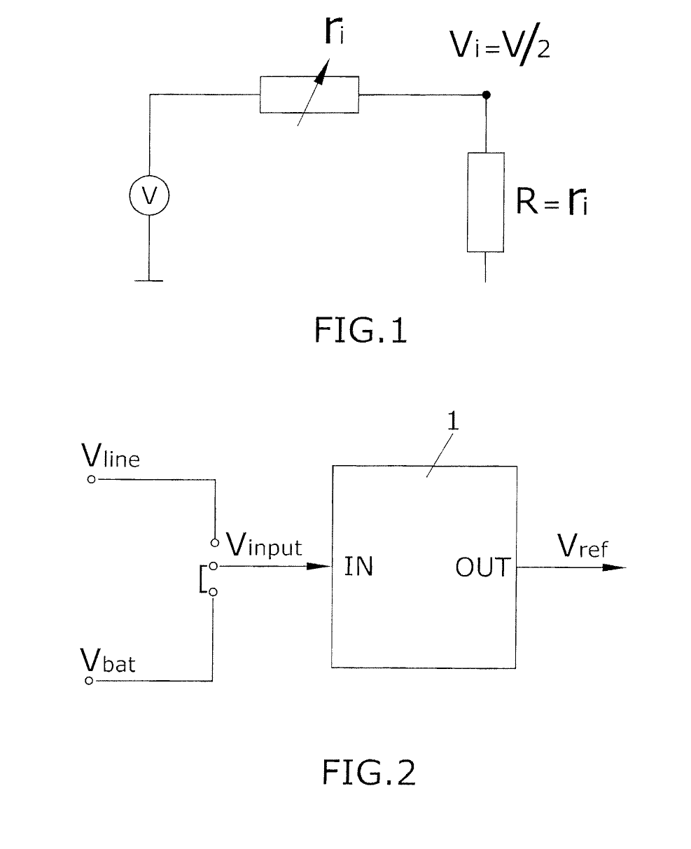

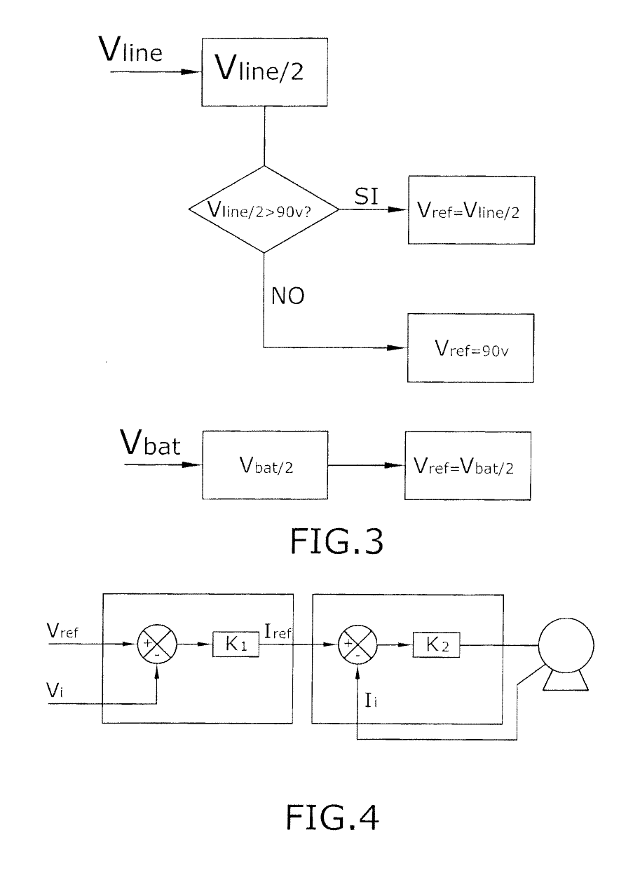

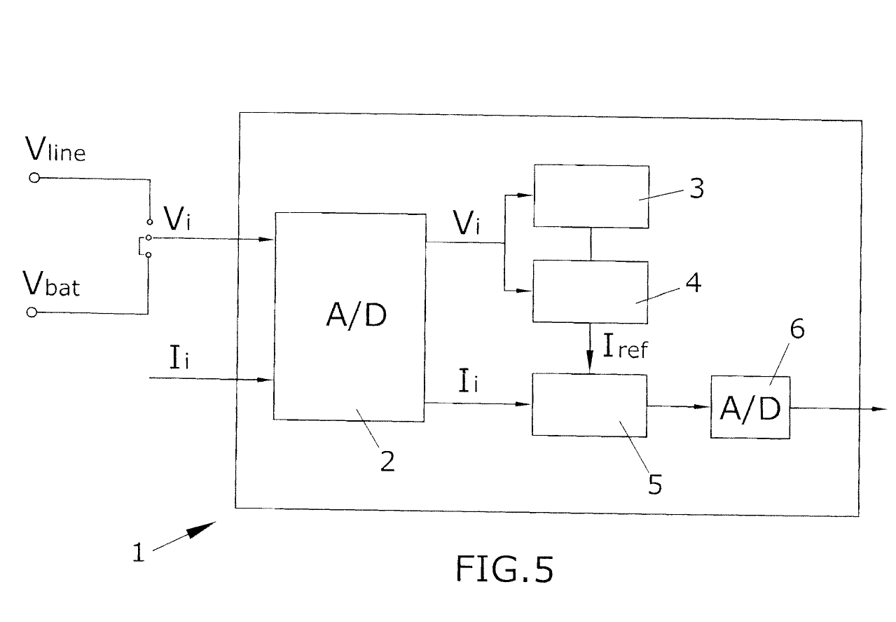

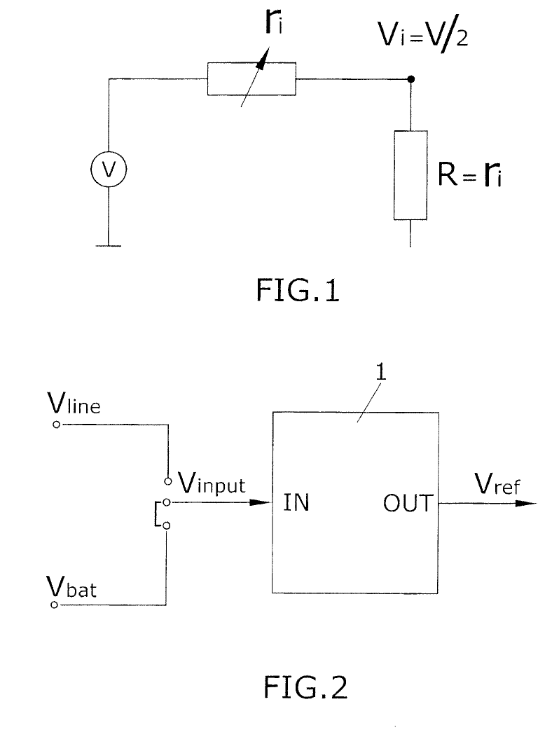

FIG. 1 shows the simplified power supply circuit for an x-ray unit, where (V) is the power supply voltage (voltage provided by the batteries (V_{bat}) or the power grid (Vₗᵢₙₑ)), (ri) is the resistance in series with the power supply voltage, which is generally variable and in the case of battery power corresponds to the internal resistance of the batteries and in the case of grid power supply corresponds to the line resistance.

Connected in parallel to this (V) and (rᵢ) series assembly is a resistance (R), which corresponds to the resistance of the x-ray unit. The maximum power is delivered when R is equal to ri, so that the unit input voltage (Vi) is equal to half of the voltage of the power supply ((V_{bat}/2) or (Vₗᵢₙₑ/2).

FIG. 2 shows a microprocessor (1) in charge of calculating the reference voltage (Vref) for obtaining the maximum power. This microprocessor receives as signals either the line voltage (Vₗᵢₙₑ) or the battery voltage (V_{bat}).

As indicated above, the unit cannot operate at voltages under 90 Volts.

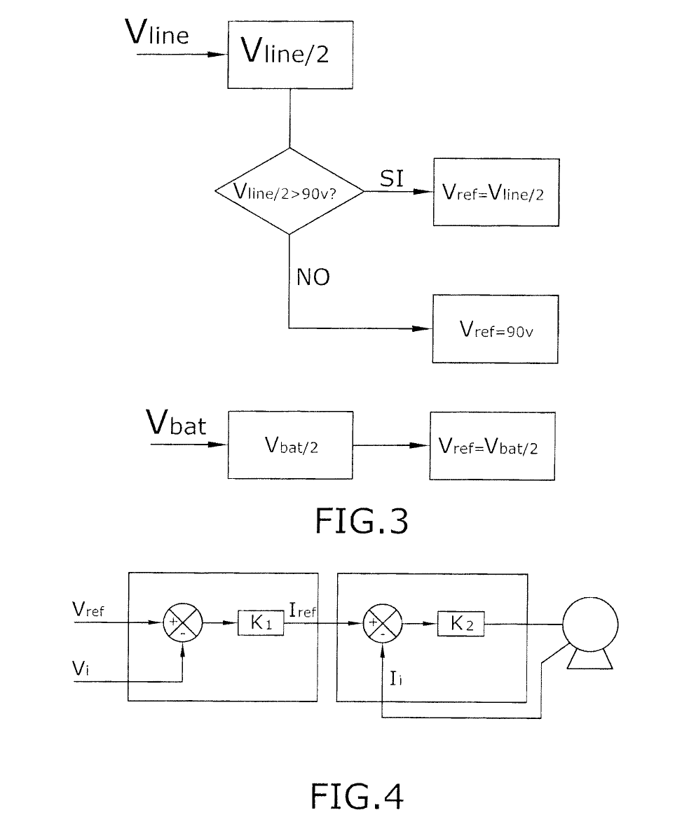

FIG. 3 shows the method used to obtain (Vref), which will be equal to (Vline/2), for supply by the grid, or (Vbat/2) for supply by a battery pack, provided (Vline/2) is greater than 90 Volts; otherwise, Vref will be 90 Volts.

FIG. 4 shows the power control process, which has a first loop (2) for regulating the power (2) followed by a second loop (3) for controlling the filament current (Ifilament).

The first regulation loop (2) compares the reference voltage (Vref) and the input voltage (Vi) to obtain a reference value for the current (I ref).

The second regulation loop (3) compares the reference current (Iref) and the input current (Iᵢ), obtaining the filament current (Ifilament), this is, the current that must be supplied to the x-ray tube.

In short, the aim is to have the x-ray unit deliver the maximum power at all times. As this occurs when the input voltage is half of the line voltage (Vline) or the battery voltage (Vbat), and as when a discharge takes place the optimum voltage required of the grid or batteries tends to be maintained, the reference current is maintained, changing the filament current (Ifilament) and changing the exposure time.

This is a dynamic and continuous process that corrects at all times the value of the tube filament current, so that if there is a deviation from the reference voltage the filament current to the x-ray tube is changed.

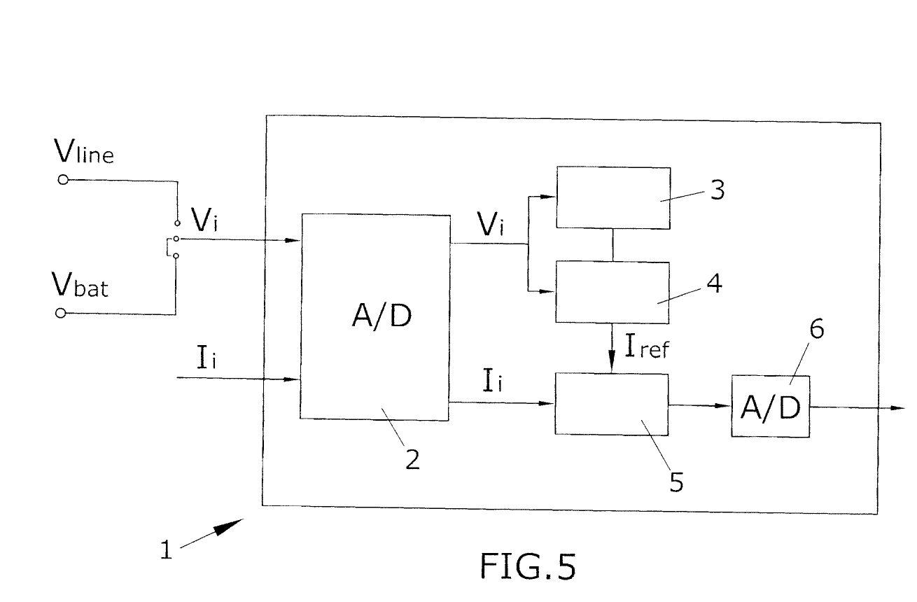

FIG. 5 shows a schematic representation of the parts or characteristics of the device used to carry out the method described above. This device comprises a microprocessor (1) having:
An A/D converter (2) for the input voltage Vi and input current
A part (3) dedicated to calculating and establishing a reference voltage (Vref)
A part (4) dedicated to regulating the power, comparing the reference voltage (Vref) and the input voltage (Vi)
A part (5) in charge of regulating the filament current (Ifilament) that compares the value of the input current (Ii) to the value of the reference current (Iref)
A D/A converter (6) in charge of supplying the filament current (Ifilament) to the x-ray tube.

The essence of this invention is not affected by variations in the materials, shape, size and arrangement of its component elements, described in a non-limiting manner that will allow its reproduction by an expert

1. A method for automatic maximum power regulation in x-ray units, comprising:
calculating a reference voltage (Vref), which if the x-ray unit is powered by a grid will be half of a line voltage (V line), provided this value is greater than 90 volts, and otherwise the reference voltage will be 90 volts, and if the x-ray unit is battery powered the reference voltage will be half of a voltage supplied by batteries (Vbat);
comparing the reference voltage (Vref) and an input voltage (Vi) supplied to the x-ray unit, regulating the voltage and thereby the power, and obtaining a reference for a current to supply (Iref); and
comparing the reference current (Iref) to the input current (Ii) to obtain a filament current (Ifil), which is the current that allows supplying the maximum power at all times and corresponds to the regulated voltage of the input voltage having as reference, the reference (Vref) which is half of the line voltage (V line), provided this value is greater than 90 volts, and otherwise the reference voltage will be 90 volts, and if it is battery powered the reference voltage will be half of the voltage supplied by the batteries (V bat).

2. A device for carrying out automatic maximum power regulation in x-ray units, comprising:
a microprocessor (1);
said microprocessor including an A/D converter (2) for the input voltage (Vi) and input current (Ii);
said microprocessor including a part (3) dedicated to calculating and establishing a reference voltage (Vref) which will be haft of the line voltage (V line), provided this value is greater than 90 volts, and otherwise the reference voltage will be 90 volts, and if it is battery powered the reference voltage will be half of the voltage supplied by the batteries (V bat);
said microprocessor including a part (4) dedicated to regulating the power and comparing the reference voltage (Vref) and the input voltage (Vi);
said microprocessor including a part (5) in charge of regulating the filament current (Ifilament) that compares the value of the input current (Ii) to the value of the reference current (Iref); and
said microprocessor including a D/A converter (6) in charge of supplying the filament current (Ifilament) to the x ray tube.
